(19) United States
(12) Patent Application Publication
(10) Pub. No.: US 2024/0030795 A1
(43) Pub. Date: Jan. 25, 2024

(54) INDUCTION RECIPROCATING LINEAR MOTOR DEVICE

(71) Applicant: Borja RODRÍGUEZ RÍOS, Santiago (CL)

(72) Inventor: Borja RODRÍGUEZ RÍOS, Santiago (CL)

(21) Appl. No.: 18/043,893

(22) PCT Filed: Sep. 3, 2020
(86) PCT No.: PCT/CL2020/050100

§ 371 Date: Mar. 2, 2023

(51) Int. Cl. H02K 33/12; H02K 1/02; H02K 9/08

(52) U.S. Cl. CPC H02K 33/12; H02K 1/02; H02K 9/08

(57) ABSTRACT

A reciprocating induction linear motor device is disclosed, built with transformer silicon laminated iron, a closed magnetic circuit, without an air gap, with two coils and an electrically conducting ring that oscillates in the central column of the transformer. The oscillation of the ring is given by the induction of enormous currents in it and the magnetic field generated by these currents when interacting with the primary winding of the transformer.

### INTRODUCTION

At the present time, certain industries have benefited from a strong and sustained rise in the price of the products they sell as a result of their activity. An example of the above is the case of mining, which for some time has experienced an increase in the price of minerals that are extracted as a result of exploitation. As a consequence of this phenomenon, the focus of the operation has lately been on increasing production to take advantage of the good price of these products. Such is the case of the exploitation of various minerals such as iron, copper, aluminum, silver, gold, etc.

To increase production and take advantage of high mineral prices, the effectiveness of critical equipment and its energy efficiency are of vital importance. This is a reality in every machinery-intensive industry and in the case of Mining, an important part of operational efficiency can be achieved in the first part of the process, called “Mine Operations”. This set of operations includes, among other stages: (i) “drilling”, in which certain specialized machines drill into the rock; (ii) “burning” (or explosion), in which each of the perforations is charged with explosives. Once these explosives are detonated, the rock is reduced to adequate sizes to be processed in later stages; (iii) and finally the “loading”, in which the rock is mounted on large trucks thanks to the operation of the loading shovel.

In a mining operation, the critical equipment that carries out the “Mine Operations” are rock drills, loading shovels and large trucks. The proportions in which this equipment is in the field are approximately one loading shovel and two drills for every 5 to 10 trucks. Therefore, one of the critical pieces of equipment in the operation of a mining company are rock drills, in which the critical variables for their operation are their reliability, the speed at which they drill the rock and the energy efficiency with which they carry it out.

In this way, any improvement that makes the operation of this type of equipment more effective and efficient can be translated into operational efficiencies of the mining operation seen as a whole.

In underground mining, the operations are the same, although the models of the equipment are different, mainly due to their height and the limited space available.

This type of equipment, such as the loading shovel and some drilling rigs, are fed with medium voltage triphasic electrical energy (8 kV or 15 kV). Therefore, the power supply that allows the proper functioning of this equipment is also critical.

### BRIEF DESCRIPTION OF THE DRAWINGS

FIG. 1 shows an electrical transformer, with a closed iron core, made from sheets of silicon iron (101).

FIG. 2 shows the electrical transformer (101) with the electrically conductive ring (201), which will act as a mechanical oscillator.

FIG. 3 shows the magnetic field (301) generated by the induced current inside the electrically conductive ring (201).

FIG. 4 shows a sectional view (201A) and a top view (201 B) of the electrically conductive ring (201).

FIG. 5 shows the directions and senses of the vector magnetic field (301) generated by the induced current (401) in the electrically conducting ring (201) and the current (501) in the primary winding (104).

FIG. 6 shows FIG. 6 shows the interaction between the vertical (503A) and horizontal (503B) components of the vector magnetic field (301) and the current (501) in the primary winding (104).

FIG. 7 shows an H-bridge (701) as a configuration of transistors that allows the direction of the currents to be reversed in a certain load (104, 702).

FIG. 8 shows the activation signals (input) of the H bridge (701) of the primary windings (104, 702).

FIG. 9 shows the voltage (in case H-bridge is a voltage source) or current (in case H-bridge is a current source) output from H-bridge (701) to the primary windings (104, 702).

FIG. 10 shows the drive signals (input) of the H bridge (701) of the primary windings (104, 702).

FIG. 11 shows the voltage (in case H-bridge is a voltage source) or current (in case H-bridge is a current source) output from H-bridge (701) to the primary windings (104, 702).

FIG. 12 shows an elevation view of the electrically conductive ring (201) and a top view of the electrically conductive ring (201).

FIG. 13 shows a complete schematic of the reciprocating induction linear motor device.

FIG. 14 shows a top view of the electrically conductive ring (201) and its axial through-holes (1401).

FIG. 15 shows an air gap (1504) in a magnetic circuit (given by the field lines (1505)).

FIG. 16 shows a variation of the linear reciprocating induction motor device, in which the electrically conductive ring (201) is double and oscillates in both columns of the transformer (101).

FIG. 17 shows the dynamic model of the induction reciprocating linear motor device.

### DETAILED DESCRIPTION

### Rock Drilling: Its Techniques and Applications in the Industry.

There are different techniques for drilling rock, depending on: (i) the application (oil wells, construction, mining production, etc.); (ii) the hardness of the surface to be drilled; (iii) the drilling diameter; (iv) the desired depth, etc. However, they all seek the same goal: to increase the drilling speed (penetration rate), consuming the least amount of energy. That is why the industry is constantly looking for different alternatives to improve speed and efficiency.

Rock Drilling Methods.

There are many methods of rock drilling. Ordered from most to least used, they are: (i) mechanical (percussion, rotation, rotary percussion); (ii) thermal (thermal lance, plasma, hot fluid, freezing); (iii) hydraulic (water jet, erosion, cavitation); (iv) sonic (high frequency vibration); (v) chemicals (micro blasting, dissolution); (vi) electrical (electric arc, magnetic induction); (vii) seismic (laser beams); (viii) nuclear (fusion and fission).

Despite the great variety of possible rock penetration systems, in mining and construction, drilling is currently carried out mainly using mechanical energy.

In this way, there are basically two types of perforation. Pure rotary drilling and rotary percussion drilling. The type of drilling chosen will basically depend on the type of ground and its hardness, the diameter of the hole and the desired depth, in order to always achieve the same objective: increase the drilling speed (known as penetration rate), with the lowest possible energy consumption.

### Rotary Drilling.

In general it is used for large diameters, up to 300 mm and soft soils (low compressive strength, measured in MPa). It consists of applying energy to the rock, making a tool rotate, together with the action of a vertical thrust force that presses the rock. It originates from oil wells, limited to soft rocks. At the beginning of the 1950s, it began to be applied to drilling for blasting. Usual diameters are between 50 mm and 300 mm.

Rotary Percussion Drilling.

In general, it is used for small and medium diameters, up to 200 mm and hard soils (medium to high compressive strength, measured in MPa). It consists of applying energy to the rock, through the impact of a piece of steel (piston) on a tool (chisel) that transmits the energy to the bottom of the hole. Especially suitable for hard rocks and small drilling diameters (50 mm to 200 mm). Depending on the place where the hammer is installed, it can be distinguished:

Percussion with Top Hammer (TOH, Top of Hole).

Top hammers are pneumatic or hydraulic actuators. Both rotation and percussion take place outside the borehole. The percussion is transmitted by the bars to the mouth of the perforation. Given this, for drilling deeper than 30 meters, these types of hammers are not effective. Top hammer drilling diameters range from (38 mm to 127 mm). For pneumatic drills the piston stroke is between 35 mm and 95 mm. Hit frequency is between 25 Hz and 55 Hz. There are also hydraulic drills, whose impact power is between 6 kW and 20 kW and a blow frequency between 30 Hz and 80 Hz.

Down the Hole Hammer Percussion (DTH, Down the Hole).

Down-the-hole hammers are pneumatic actuators. The drive of the piston is through compressed air and the percussion takes place inside the perforation mouth. Rotation takes place outside of the borehole. Its penetration rate is quite homogeneous with increasing depth and depths greater than 100 m can be achieved.

Down-the-hole hammer drilling diameters range from (85 mm to 200 mm). Drilling speeds are between 0.5 and 0.6 m/min for diameters between 105 mm and 165 mm. The beat frequency is between 10 Hz and 26 Hz (blows per second). Piston strokes are in the order of 100 mm and compete with hydraulic top hammer drilling for ranges from 76 mm to 125 mm. Regarding the efficiency of the tool, it is about 10%. That is, to deliver 30 kW to the rock, the air compressor consumes around 300 kW.

The widely used rotary percussion techniques (pneumatic and hydraulic) use a fluid (air or oil, respectively) to transmit energy to the percussion tool. This fluid is centrally pressurized through a compressor or an hydraulic pump, respectively, in such a way that the flow transmitted to the tool is driven by this pressurized fluid. Then, the power delivered to the tool is the product of pressure times flow, with flow being a pressure-dependent variable. If there is need to increase the power transmitted to the tool through the fluid, the pressure with which the fluid is driven needs to be increased. The resultant higher pressure increases the flow. In other words, both variables are tied together.

Now, from the point of view of the tool, the power received by the pressurized fluid is transformed into power delivered to the rock, which is the product of the kinetic energy of the piston when striking the chisel, times the impact frequency of the piston when hitting the chisel. To achieve more drilling speed, the impact frequency must be increased, ensuring minimal impact to break the rock. However, with current tools (pneumatic and hydraulic), to increase the impact frequency, the power to the tool must be increased and the final result is that the impact frequency and the energy with which the tool is impacted are increased at the same time.

This is not the most efficient, since in theory it would not be necessary to increase the impact energy, because the rock is already breaking. The desirable thing would be to transform the installed power into frequency, keeping the impact energy at a minimum to break the rock.

On the other hand, experience in the industry shows that, for an installed power on the drilling rig, a higher drilling speed can be achieved if it is distributed independently the energy delivered to the surface and on the other hand the impact frequency.

Given the above, there are several attempts to develop devices that are more flexible in terms of controlling their operating parameters (energy and frequency). In this sense, electrical devices allow to control voltages, currents, frequencies, etc. and on the other hand, the energization is already available in the mining operation.

Then the motivations to study electric hammers are clear: electric traction systems are characterized by high efficiency, and they can be controlled remotely. Then, the percussion frequency could eventually be controlled, independently of the impact, while keeping a high energy efficiency of the cycle.

In other words, a device is sought that it is capable of delivering high power to the rock and at the same time is it flexible so it can modify its operating conditions, keeping its efficiency within acceptable ranges.

The reason that justifies the development of an electric hammer is based precisely on the properties that electrical systems present: high efficiency and remote parameter control. It is interesting then, to combine the properties of the various electrical systems with the requirements and characteristics of rock drilling.

Specifically, the possibility of varying the parameters of an electromechanical system makes it possible to vary the percussion frequencies while maintaining a high efficiency of the cycle. By adjusting the parameters for different rocks, a higher penetration rate could be achieved.

The massive use of any drilling equipment that uses electrical energy directly to generate percussion on the rock is not seen in the market. However, the specification of the rock drilling technique, and the new applications that currently require the use of hammers, motivate the study of new possibilities that make the rock drilling process faster and more efficient.

### State of the Art of Electric Percussion Tools.

There are a variety of patents and scientific publications for electric drilling tools. The vast majority of them contemplate the use of solenoids that move ferromagnetic masses in combination with springs to generate an oscillatory movement. Such is the case of U.S. Pat. No. 6,201,362 B1, which proposes a ferrous mass located inside electrical coils and which is driven by one or two coils. Together, the ferrous mass and a coil form a solenoid. The coils drive the ferrous mass against a chisel and after impact, the coils lift the mass again, generating a reciprocating motion. When the coils are excited with electrical energy coming from outside the device (it can be alternating or continuous), the ferrous mass is attracted to the center of the coil, since in this way the energy of the system is at a minimum and the ferrous mass finds a balance inside the coil, in its center. The reciprocating movement is achieved by changing the position of the ferrous mass from one coil to another and the patent proposes a power system that extends the life of the coils through the use of an inertia wheel that stores energy externally to the device.

Another case of an electric rock drilling tool is U.S. Pat. No. 5,168,939A, which proposes an electromagnetic gun system for accelerating a ferrous mass that passes through the center of successive coils that accelerate it. The coils are excited sequentially in a feedback way according to the position of the ferrous mass. This tool is designed to hit very hard, but with a very low frequency. That is, a high kinetic energy (½*mv\hat{ }2) of impact (measured in Joules) in combination with a low frequency (measured in Hz=1/second). The product of impact energy by impact frequency, results in the power delivered to the rock (measured in Watts=Joules/second). So if the frequency is too low, the power delivered to the rock is low and as can be assumed the penetration rate will be low.

Both power tools, like those proposed in U.S. Pat. Nos. 6,520,269, 4,215,297, 4,015,671, 2,861,778, 1,941,655, 1,725,504, CN 205,317,438 U, CN 1,061,922 A, disclose similar systems in terms of driving coils to generate a reciprocating movement of a ferrous mass using coils that attract the ferrous mass to the center of the coil.

However, the configuration in all these patents considers the use of open magnetic circuits (1505) at some point in the iron, giving spaces for air gaps (1504). In the configurations proposed in the cited patents, the air gaps are present to allow the movement of the ferrous mass. These air gaps (1504) are air gaps (1509) with a very low magnetic permeability compared to the iron zone (1510) which has a magnetic permeability several orders of magnitude higher. Depending on the material, it can be of the order of 100 to 1000 times. The effect of this air gap (1504) is that the magnetic circuit (1505) finds it difficult to generate a high field density inside the iron, generating a border effect (1502), in which the field becomes less dense (fewer lines field (1501) per unit area). As in electrical circuits, in which a high resistance prevents the passage of current, in the case of magnetic circuits, a high reluctance (due to the air gaps) prevents the passage of magnetic flux. This generates that for the same excitation (magnetomotive force N*I, given by the product of the winding of N turns (1507) and the current circulating in the winding (1508)), a lower field density is obtained (magnetic field lines (1501) divided by the cross section of the iron core (1503)) in the magnetic core. In other words, in order to generate a magnetic field density that is good enough to generate high power, it is necessary to consume a lot of electrical energy.

In this way, those proposals that include air gaps (1504) either consume a lot of energy or generate little mechanical movement.

Other patents talk about linear stepper motors, like the 1926 U.S. Pat. No. 1,720,854, but also consider air gaps to allow mechanical movement. This patent considers a complex configuration since the forces of attraction between the iron elements are high and for this reason it contemplates the use of linear bearings or systems that ensure a very precise centering of the mobile element. On the other hand, the use of windings that must be powered electrically in the mobile zone implies the need for mobile electrical contacts (brushes, carbons, etc.) that generate many maintenance needs that make the operation of the device very expensive or decidedly so unreliable.

Other alternatives proposed in scientific publications (Tao, Bekken and Zhang et al) correspond to permanent magnet synchronous linear motors to generate translational and reciprocating motion. In these alternatives, the stator contains the permanent magnets and the element that generates the movement has only coils. However, the use of permanent magnets in applications with high temperatures, high vibration and high shock is not desirable, especially given the structure of modern permanent magnets, manufactured by sintering. This manufacturing process consists of compacting at high pressure the metallic and/or ceramic powders of certain particular materials, homogeneously mixed and, once compacted, carrying out a heat treatment at a temperature below the melting temperature of the mixture, obtaining a consolidated and compact piece.

Technical Problems Solved by this Development.

An electric drilling device is proposed that includes a linear reciprocating induction motor, confined inside an electric transformer (101), and that through an air chamber (1704) delivers power to the percussion piston (1705). This one hits the chisel (1706) which is what finally destroys the rock. The characteristics of this device are: (i) its energy efficiency (electric power consumed versus power delivered to the rock); (ii) flexibility to control operating parameters, such as impact frequency, stroke, and impact energy; (iii) low capital cost because, unlike hydraulic and pneumatic drills, the entire tool is self-contained. That is, hydraulic and pneumatic drills require a hydraulic pump and an air compressor, respectively, to drive the fluid to the tool. These hydraulic pumps and air compressors are equipment with a high capital cost due to the number of parts and pieces that make up the equipment. However, in the case of the proposed development, the same transformer (101) generates the movement of the electrically conductive ring (201) and the quantity and interaction of the parts of an electrical transformer is much lower than that of a pneumatic pump or an air compressor; (iv) low maintenance cost because, unlike hydraulic and pneumatic drills that require intensive maintenance, the entire tool of the present development is self-contained. The maintenance of electrical equipment, specifically transformers, is much lower due to the lower labor force and robustness of the equipment, than hydraulic and pneumatic equipment, especially when the latter depend on internal combustion engines to generate movement. In this way, hydraulic and pneumatic drills require a hydraulic pump or an air compressor, respectively, to push the fluid to the tool, requiring two elements to generate the desired effect: the fluid drive element and the drilling tool. As we mentioned earlier, hydraulic pumps and air compressors are maintenance-intensive equipment. However, in the case of the proposed development, the same transformer generates the movement of the electrically conductive ring and this is maintenance free.

The widely used rotary percussion techniques (pneumatic and hydraulic) use a fluid (air or oil, respectively) to transmit energy to the percussion tool. This fluid is centrally pressurized through a compressor or a hydraulic pump, respectively, in such a way that the flow transmitted to the tool is driven by this pressurized fluid. Then, the power delivered to the tool is the product of pressure times flow, with flow being a pressure-dependent variable. If it is needed more power transmitted to the tool through the fluid, it will be necessary to increase the pressure with which the fluid is driven and that higher pressure increases the flow of the fluid. In other words, both variables are tied.

Now, from the point of view of the tool, the power received by the pressurized fluid is transformed into power delivered to the rock, which is the product of the kinetic energy of the piston when striking the chisel, times the impact frequency of the piston when hitting the chisel. To achieve more drilling speed, the impact frequency must be increased, ensuring minimal impact to break the rock. However, with current tools (pneumatic and hydraulic), to increase the impact frequency, the power to the tool must be increased and the final result is that the impact frequency and the energy with which the tool is impacted are increased at the same time.

This is not the most efficient, since in theory it would not be necessary to increase the impact energy because the rock is already breaking. The desirable thing would be to transform the installed power into frequency, keeping the impact energy at a minimum to break the rock.

On the other hand, experience in the industry shows that, for an installed power on the drilling rig, a higher drilling speed can be achieved if it is distributed independently the energy delivered to the surface and on the other hand the impact frequency.

Then the motivations to study electric hammers are clear: electric traction systems are characterized by high efficiency, and they can be controlled remotely. Then, the percussion frequency could eventually be controlled, independently of the impact, while keeping a high energy efficiency of the cycle.

In other words, a small size device is sought (which does not depend on the size of its installed power and delivered to the rock) that it is capable of delivering high power to the rock and at the same time is it flexible so it can modify its operating conditions, keeping its efficiency within acceptable ranges.

The reason that justifies the development of an electric hammer is based precisely on the properties that electrical systems present: high efficiency and remote parameter control. It is interesting then, to combine the properties of the various electrical systems with the requirements and characteristics of rock drilling.

Specifically, the possibility of varying the parameters of an electromechanical system makes it possible to vary the percussion frequencies while maintaining a high efficiency of the cycle. By adjusting the parameters for different rocks, a higher penetration rate can be achieved.

The present development proposes an electric drilling device that comprises a linear reciprocating induction motor, confined inside an electric transformer (101), and that through an air chamber (1704) delivers power to the percussion piston (1705). This one hits the chisel (1706) which is what finally destroys the rock. The characteristics of this device are its efficiency and flexibility to control the operating parameters, such as impact frequency, stroke and impact energy and a small size, independent of power requirements compared to known hydraulic and pneumatic systems.

In this way, with respect to rotary percussive tools, both hydraulic and pneumatic, a configuration such as the one proposed, solves the technical problems of: (i) energy efficiency, in the sense that a significant proportion of the power consumed by the equipment can be converted into mechanical power and this delivered to the rock; (ii) a size of the equipment independent of the power required in comparison with the hydraulic and pneumatic systems, and (iii) control of the parameters that allow to exchange impact energy in impact frequency. For this, the proposed device has two degrees of freedom:
a) The frequency with which the lower and upper primary windings (104) are excited alternately. Each time one of them is excited, the electrically conductive ring (201) moves, therefore, the enveloping excitation frequency directly determines the oscillation frequency of the electrically conductive ring (201).
b) The stroke of the electrically conductive ring, determined by the distance between the upper and lower primary windings (104). As can be understood, at a greater distance, the frequency of the electrically conductive ring (201) will be lower and vice versa.

With these possibilities of externally changing the frequency of the electrically conductive ring (201), the device can better face the possible scenarios:

I. Hard Rock.

In this scenario, the tool must hit with a strong impact to break the rock. In this way, the primary windings (104) must be separated ensuring a greater stroke of the electrically conductive ring (201). In such a way, the electrically conductive ring (201) will experiment a greater travel with thrust from the coils combined with the gravity accelerating the electrically conductive ring (201). This will result in a greater speed of the electrically conductive ring (201) at the moment of impact and, therefore, greater impact energy delivered to the rock. Once the minimum impact to break the rock has been achieved, all the installed power can be transformed into a higher oscillation frequency of the electrically conductive ring (201) which in turn will cause a higher impact frequency. In this way it will be possible to increase the drilling speed as much as possible. This increase in oscillation frequency is achieved by increasing the frequency of the enveloping curves (801, 803, 901, 903, 1001, 1003, 1101, 1103).

II. Medium Rock.

In this scenario, the tool must hit with a minor impact to break the rock. In this way, the distance between the primary windings (104) must be shortened and with it, shorten the stroke of the electrically conductive ring (201), accelerating it just enough to deliver the minimum impact energy to the rock to break it. The great advantage of shortening the stroke is that it allows to further increase the frequency with which the upper and lower primary windings (104) alternate. Once the minimum impact to break the rock has been achieved, all the installed power can be transformed into a higher oscillation frequency of the electrically conductive ring (201) which in turn will cause a higher impact frequency. In this way it will be possible to increase the drilling speed as much as possible. This increase in oscillation frequency is achieved by increasing the frequency of the enveloping curves (801, 803, 901, 903, 1001, 1003, 1101, 1103).

Regarding percussion power tools, the solution presented in this document differs strongly in:
1) The proposed linear induction motor device is of a very simple construction. It does not contain brushes, carbons, slip rings or commutators, which results in fewer parts and easy maintenance of the equipment with fewer labor costs for this purpose.
2) The linear induction motor device of the present development is of a very robust construction, which makes it a reliable device. It does not have delicate elements, such as permanent magnets or electrical contacts with moving parts. This results in few failures and a low turnover of spare parts. Regarding power tools that use permanent magnets, the heavy duty use will cause brittleness of magnets in an environment of high vibration and dust with strong shock. Likewise, in electric tools with permanent magnets there is a risk of demagnetization due to high temperature (Curie effect).
3) The proposed linear induction motor device does not have electrical contacts in the moving parts. Due to the absence of brushes and carbons as electrical contact elements, there are no sparks and therefore it can be operated in dangerous conditions, such as coal mines. This makes it a higher security device.
4) It does not have air gaps to generate induction in the electrically conductive ring (201). This results in high efficiency when comparing the electrical power consumed by the device with the mechanical power delivered to the rock, expressed as impact energy times impact frequency.

In addition to the above, the axial perforations (1401) help to substantially improve the efficiency of the system, since they cool the ring and reduce air resistance.
5) By varying the induction frequency (802, 804, 902, 904, 1002, 1004, 1102, 1104), more current is generated in the ring, since the current induced in the ring is proportional to the induction frequency. This gives one more degree of freedom to the proposed configuration since materials such as ferrite could be used in the event that the silicon iron presents a limitation due to the induction frequency. Silicon iron is normally used for applications whose working frequencies are less than 1 kHz, since parasitic currents begin to make silicon iron very inefficient.

### Description of the Development Itself.

It should be understood that the present development is not limited to the particular methodology, compounds, materials, manufacturing techniques, uses and applications described herein, as these may vary. It should also be understood that the terminology employed herein is used for the sole purpose of describing a particular representation and is not intended to limit the scope and potential of the present development.

It should be noted that the device, system, procedure, use and method, here, in the specification and throughout the text that the singular does not exclude the plural, unless the context clearly implies it. So, for example, a reference to a “device or system” is a reference to one or more devices or systems and includes equivalents known to those knowledgeable in the art. Similarly, as another example, a reference to “a step”, “a stage” or a “mode” is a reference to one or more steps, stages or modes and may include implicit and sub-steps, stages or modes or supervening.

All the conjunctions used must be understood in their least restrictive and most inclusive sense possible. Thus, for example, the conjunction “or” must be understood in its orthodox logical sense, and not as an exclusive “or”, unless the context or the text expressly requires or indicates it. The structures, materials and/or elements described must also be understood to refer to functionally equivalent ones and thus avoid endless exhaustive enumerations.

The expressions used to indicate approximations or conceptualizations must be understood in this way unless the context mandates a different interpretation.

All names and technical and/or scientific terms used herein have the common meaning given by a common person, qualified in these matters, unless otherwise expressly indicated.

The methods, techniques, elements, devices and systems are described, although methods, techniques, elements, devices and systems similar and/or equivalent to those described may be used or preferred in the practice and/or tests of the present development.

All patents and other publications are incorporated as references, with the purpose of describing and/or informing, for example, the methodologies described in said publications, which may be useful in relation to the present development.

These publications are included only for their information prior to the filing date of this patent application.

In this regard, nothing should be considered as an admission or acceptance, rejection, or exclusion, that the authors and/or inventors are not legitimated to be so, or that said publications are pre-dated by virtue of previous ones, or for any other reason.

To provide clarity to this development, the following concepts will be defined:
Air gap: the air gap is the region located in the air between the two magnetic poles of a magnet or an electromagnet. The air gap introduces a magnetic reluctance into the magnetic circuit, that is, a resistance to the passage of a magnetic flux when influenced by a magnetic field.
Magnetic Field Line: Magnetic field lines are an abstraction of the invisible lines that run in the magnetic circuit from the north pole to the south pole. Magnetic field lines are a consequence of the magnetization of permanent magnets or electromagnets and characterize the geometric arrangement of their magnetic fields. The stronger a magnetic field is, the denser the magnetic field lines. If iron powder is sprinkled on a piece of paper and placed in position just above the magnet, the iron powder will pick up structures that show the course of magnetic field lines.
H-Bridge—An H-bridge is an electronic circuit typically used to enable a DC electric motor to rotate in both forward and reverse directions. They are widely used in robotics and as power converters. H-bridges are available as integrated circuits, but they can also be built from discrete components. In this development, it is used to generate the excitation of the primary windings (401) with a frequency other than the electrical network (50 Hz or 60 Hz), which allows the double function: inducing currents in the electrically conductive ring (201) from of a high frequency excitation and at the same time make it alternate between the primary windings (401) with a low frequency excitation, the latter being the enveloping curve of the excitation signals.
Enveloping curve: In geometry, a enveloping curve of a family of curves in the plane is a curve that is tangent to each member of the family at some point, and these points of tangency together form the complete enveloping curve. In the case of this punctual development, it refers to the curve that surrounds the signals, voltages or currents of high frequency, to graph the signals, voltages or currents of low frequency.

The linear reciprocating induction motor device for percussion applications that is proposed in the present development, comprises an electrically conductive ring (201) that oscillates inside a single-phase transformer (101), with a closed ferrous core (annealed iron wire or ferrite or preferably laminated silicon iron) with two primary windings (104) of enameled annealed wire, which can be copper or aluminum. The primary windings (104) can also be made of annealed copper tubing, internally cooled with soft water, as is normally done in induction heating appliances. If this is the case, the pipe must be externally insulated with tape or enamel and then wound to form the coil. This wire or pipe is wound on a plastic spool, this being a dry transformer (not submerged in oil). The primary windings (104) are energized alternately with direct or alternating current, and in a complementary way, implying that while one of the primary windings is energized, the other is not, and vice versa. The oscillation of the electrically conductive ring (201) is produced by the interaction between the magnetic field (301) and the current (501) of the primary winding (104).

In this way, the current (501) from the primary winding (104) produces an alternating magnetic field (102) within the laminated silicon iron (101) of the transformer. The ferrous material of the transformer can also be annealed iron wire or ferrite or any other material that concentrates the magnetic field, preferably laminated silicon iron with the greatest number of field lines prior to saturation. By Faraday's law and Lenz's law, this alternating magnetic field (102) induces an alternating current (401) inside the electrically conducting ring (201) in the opposite direction to the current (501) of the primary winding (104). The induced current (401) within the electrically conductive ring (201) generates an alternating magnetic field (301) that opposes the original magnetic field (102).

Since the alternating magnetic field (301) is a vector field, each field line has a vertical component (503A) and a horizontal component (503B).

In this way, the horizontal component (503B) of the magnetic (301) and the current (501) of the primary winding (104) interact with each other and their vector product (F=I×B) generates a vertical repulsive force (601) between the electrically conductive ring (201) and the primary winding (104). This vertical repulsive force (601) is what allows the electrically conductive ring (201) to oscillate in the central column of the closed-core transformer.

Likewise, the vertical component (503A) of the magnetic field (301) and the current (501) of the primary winding (104) interact with each other and their vector product (F=I×B) generates a radial horizontal force (602) between the electrically conductive ring (201) and the primary winding (104). This radial horizontal force (602) has a resultant equal to zero, since it cancels (vectorial sum equal to zero). This radial horizontal force (602) allows the electrically conducting ring (201) to be centered and to move practically without friction along the vertical column of the transformer (101).

The oscillating movement of the electrically conducting ring (201) is generated by alternately energizing the lower primary winding (104) and the upper primary winding (104). Then the vertical force of repulsion (601) is upwards when the lower primary winding (104) is energized, and the electrically conductive ring (201) moves upwards. When the electrically conductive ring (201) is close to the upper primary winding (104), it is energized and the vertical repulsion force (601) is downwards, generating a displacement of the ring towards the lower primary winding (104). And so on.

The excitation of the upper and lower primary windings (104, 702) can be done directly from the electrical network (103), with frequencies of 50 Hz or 60 Hz, as the case may be, or through a special source, such as an H bridge (701). There must be one H-bridge for each primary winding (104, 702).

If it is desired to excite the primary windings (104, 702) directly from the electrical network (103), the excitation frequency that generates induction in the electrically conductive ring (201) is the frequency of the network (902, 904, 1102, 1104). And each primary winding (104, 702) must be alternately energized through some switching device, such as a relay (using Normal Open and Normal Close states), two solid state relays, or transistors. The alternation with which the lower primary winding (104, 702) is energized and later the upper primary winding (104, 702) and so on, will be the oscillation frequency of the electrically conductive ring (201) inside the transformer (101), which corresponds to the enveloping curves (901, 903) for a duty cycle of 50% and to the enveloping curves (1101, 1103) for a duty cycle of less than 50%.

If it is desired to drive the primary windings (104, 702) with an H-bridge (701), the same H-bridge (701) allows voltage and current to be delivered to the primary windings (104, 702) to achieve high (induction) frequency. and additionally, the low frequency, (alternating between them) to oscillate the electrically conductive ring (201).

The H bridge (701) allows the primary windings (104, 702) to be energized to achieve a current in one direction (positive to the right) with the activation of the transistors 703 (MOSFET, IGBT, BJT, among others). An instant later in time (half an induction cycle) the transistors 703 are no longer powered and the transistors 704 are powered to generate a current flow in the reverse direction (positive to the left).

For a 50% duty cycle, the drive signals of the H bridge (701) of the primary windings (104, 702) must be 180° out of phase, in such a way as to achieve the oscillation of the electrically conductive ring (201). In this way, for a 50% duty cycle, the drive signal of the H-bridge (701) for the upper primary winding (104, 702) is the induction signal (802) and also the enveloping curve (801) that generates the oscillation of the electrically conductive ring (201). Likewise, the drive signal of the H bridge (701) for the lower primary winding (104, 702) is the induction signal (804) and also the enveloping curve (803) that generates the oscillation of the electrically conductive ring (201).

For a duty cycle of less than 50%, the drive signal of the H bridge (701) for the upper primary winding (104, 702) is the induction signal (1002) and also the enveloping curve (1001) that generates the oscillation of the electrically conductive ring (201). Likewise, the drive signal of the H-bridge (701) for the lower primary winding (104, 702) is the induction signal (1004) and also the enveloping curve (1003) that generates the oscillation of the electrically conductive ring (201).

With the use of modern sources such as an H-bridge, as a current or voltage source, one can have a lot of flexibility in the oscillation frequency parameters (801, 803, 901, 903, 1001, 1003, 1101, 1103) of the electrically conductive ring (201). Externally to the device, the excitation frequency of the coils (enveloping curve) (801, 803, 901, 903, 1001, 1003, 1101, 1103) can be varied.

It is advisable to use modern sources such as the H bridge as a voltage or current source, since for this device to be competitive, the electrically conductive ring (201) must be able to oscillate at more than 30 Hz. For this, the induction frequencies must be substantially higher (of the order of 10 times more), so that with each oscillation the ring has at least one complete induction cycle and thus ensure that the currents inside it are effectively very high.

In addition to the above, the path of the electrically conductive ring (201) inside the transformer (stroke) can be varied. The stroke that the electrically conductive ring travels is determined by the distance between the upper and lower primary windings (104). As can be understood, at a greater distance, the frequency of the electrically conductive ring (201) will be lower and vice versa.

The proposed configuration is that of a closed-core single-phase transformer comprising:
(i) An arrangement of iron-silicon sheets for an electric transformer (101) that generates a closed magnetic circuit (without an air gap), and this iron-silicon may be grain-oriented or a similar material, which supports a high magnetic field density (102) prior to its saturation. This field density is measured in number of field lines or Tesla and before saturation it can go from 10,000 lines or 1 Tesla to 20,000 lines or 2.0 Tesla, depending on the material. The material must have the property of concentrating the field lines, generating a high field density in a small volume of transformer (101). As an alternative to the silicon iron sheets, the material that concentrates the magnetic field can be annealed iron wire or ferrite.
(ii) Two primary windings (104) that are alternately excited with direct current or preferably alternating current (103). This primary winding (104) consists of a coil of annealed enameled copper or aluminum wire, dielectrically insulated using paper, treated paper, elastomers, among others for this purpose, which, electrically powered, generates the magnetic field in the iron, which in turn induces gigantic currents in the electrically conducting ring (201). For the induction phenomenon to occur, the magnetic field in the laminated silicon iron (101) must be varying over time. In this way, if the primary winding (104) is supplied with direct current (501), the induced current (401) in the electrically conductive ring (201) will occur only in the transient period, until the winding current (501)) stops varying in time and the induced current (401) inside the electrically conducting ring (201) reaches zero magnitude. Alternatively, the primary winding (104) can also be made of annealed copper tubing, so that it can be internally cooled with some fluid, preferably soft water. If this is the case, the pipe must be externally insulated with some material such as electrical insulating tape that also supports temperature, such as fiberglass tape, enameled or not. It can also be simply enameled.
(iii) An electrically conductive ring (201) of low cost, low specific weight, low electrical resistivity and high thermal conductivity. A good candidate for a material that meets all these conditions is aluminum and its alloys, without being restricted just to this material. This electrically conductive ring (201) will act as the secondary winding of the transformer, with a single turn short-circuited in its winding. This will generate a current (401) inside the electrically conductive ring (201) of the order of hundreds of thousands of amperes and will depend on the temperature of the aluminum, its resistivity, the mean perimeter of the electrically conductive ring (201), the cross section of the electrically conductive ring (201), of the cross section of the silicon iron (101), of the magnetic field density (102), and of the excitation frequency of the primary windings (104).

The combination between a closed magnetic circuit (101), without an air gap, with a great capacity to concentrate the magnetic field (102) and a primary winding (104) that generates that magnetic field, inducing gigantic currents in the electrically conductive ring (201), it causes a very efficient system in the sense that it does not generate losses for its operation.

To assure the effectiveness (movement) and efficiency (ratio between electrical energy consumed and energy transformed into mechanical movement) of the system and reduce operating losses, cooling of the electrically conductive ring (201) must be ensured, which is achieved preferentially, by the surrounding air generated by the movement of the ring, without ruling out, but being only an option, the use of inert or dielectric gases such as nitrogen, argon, SF6, among others. This is due to the fact that if the induced current (401) in the electrically conductive ring (201) is hundreds of thousands of amperes and the current density is of the order of hundreds of amperes per square millimeter, the electrically conductive ring (201) will tend to heat up and this will generate on the one hand: (i) losses in the system since part of the power consumed by the reciprocating linear motor device will be converted into heat, but on the other hand (ii) less movement of the electrically conductive ring (201). This lesser movement is due to the fact that when the electrically conductive ring (201) heats up, its electrical resistance will increase, and the induced current (401) will decrease. As the induced current (401) decreases, the intensity of the magnetic field (301) associated with the induced currents (401) in the electrically conductive ring (201) will decrease.

That is why the electrically conductive ring (201) considers axial perforations (1401) parallel to its direction of movement. In this way, by forced convection and thanks to the good thermal conductivity of aluminum, the heat generated in the electrically conductive ring (201) is displaced by the high current density in it.

The axial perforations (1401) that cool the electrically conductive ring (201), also decrease the resistance of the air to the displacement of the ring. Since the average speed of the electrically conductive ring (201) is of the order of tens of meters per second, and the resistance with the air increases quadratically with the speed, decreasing this aerodynamic resistance increases the efficiency of the system. That is why the electrically conductive ring (201) considers axial perforations (1401).

The mobile element is simply an electrically conductive ring (201), preferably made of aluminum or its alloys, without ruling out other materials, in which currents (401) are induced without electrical contact of any kind. That is, the active component of the conductive ring (201) that generates reciprocating movement, are induced currents. Unlike those solutions that propose permanent magnets or electrical loops in the mobile element that must make contact with the stator, the electrically conductive ring (201) is capable of handling hundreds or thousands of amperes without making electrical contact with the rest of the equipment.

The reciprocating vertical linear movement is achieved from a slip fit between the inside diameter of the electrically conductive ring (201) and the central column of the transformer (101). That is, linear bearings to restrict radial movements are not required, given by the resulting radial forces between the transformer (101) and the electrically conductive ring (201). This is because there are no attractive forces between the laminated silicon iron of the transformer (101) and the electrically conductive ring (201). In fact, the radial forces (602) that exist between the vertical component (503A) of the magnetic field (301) generated by the electrically conductive ring (201) and the current of the coil (104), cancel around the entire perimeter of the electrically conductive ring (201).

### Manufacturing Method of Induction Reciprocating Linear Motor Device

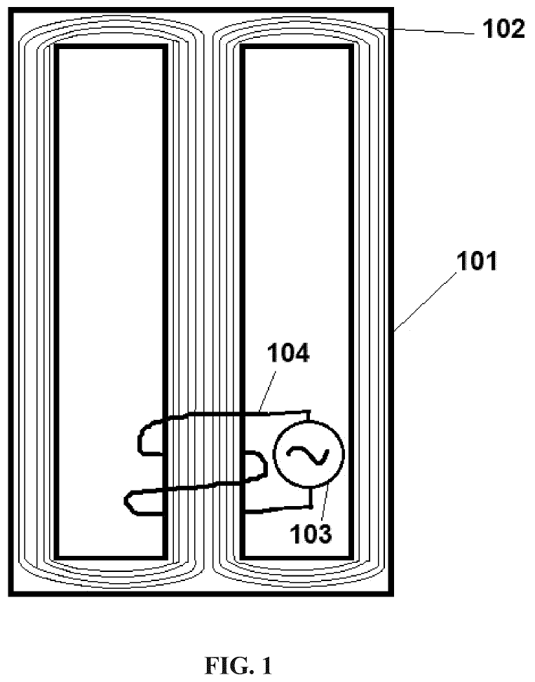

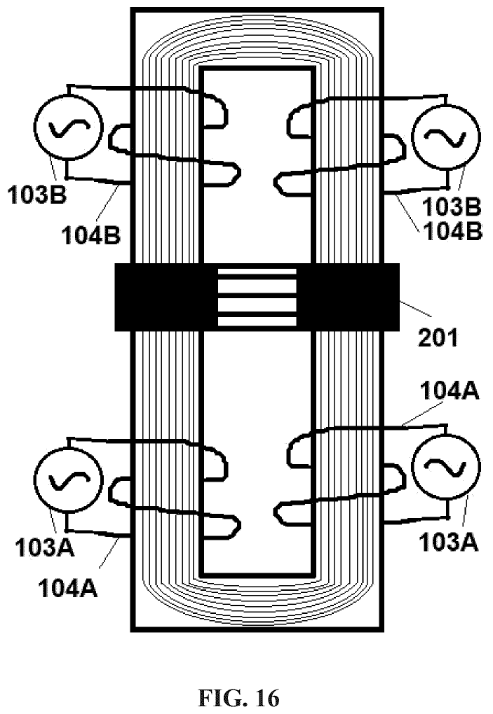

The manufacturing method of the reciprocating induction linear motor device has variations, depending on the format of the ferrous core that is used. It basically depends on: (i) the core can be opened and closed during the manufacturing process, or, (ii) that once the core is manufactured, it can no longer be opened again.
(i) If the format of the core is such that it can be opened and closed, then the manufacturing method is such that the laminated silicon iron or ferrite or any other material that concentrates the magnetic field, is assembled sheet by sheet if it is the case, and it is left open to incorporate the rest of the elements (springs, electrically conductive ring (201), primary windings (104)).
a. If the design of the transformer core is such that it consists of two elements E and I, as in FIG. 1, it is inserted into the central column of the transformer in the following order: the lower primary winding, the lower spring in the center of the lower primary winding, the electrically conductive ring (201), the upper primary winding, and the upper spring in the center of the upper primary winding. Once all the elements are introduced, the transformer is closed, adding the element of the ferrous core in the form of I to close the magnetic core of the transformer.
b. If the design of the transformer core is such that it deals with two elements C and I, like the one in FIG. 16, it is introduced in one or both columns of the transformer in that order: the lower primary winding, the lower spring in the center of the lower primary winding, the electrically conductive ring (201), the upper primary winding, and the upper spring in the center of the upper primary winding. Once all the elements are introduced, the transformer is closed, adding the element of the ferrous core in the form of I to close the magnetic core of the transformer.
(ii) If the format of the transformer core is such that it can NOT be reopened, then there are variations in the manufacturing method of the device. This method can be used when, for reasons of cost, annealed iron wire is used and the first manufacturing step is to assemble the ferrous core from several turns of iron wire. In this case the procedure will be:
a. Pass several turns of annealed iron wire through the center of the springs, electric conductive ring (201) and primary windings (104), until forming an iron core with enough section for the proper functioning of the device. In this way, at the same time that they go through the center of the elements (springs, coils and ring), the nucleus is formed.
b. The iron core is assembled from several turns of the annealed iron wire. Once the already closed ferrous core is assembled, later the reels for the coils are divided into two parts. The parts of the reels are inserted into the ferrous core and each primary winding (104) is wound up, turning the reel inside the iron core. The springs are inserted into the iron core and finally the electrically conductive ring (201) is open in two parts, they are inserted into the core and joined to give rise to the electrically conductive short-circuited ring (201).

### Application Example

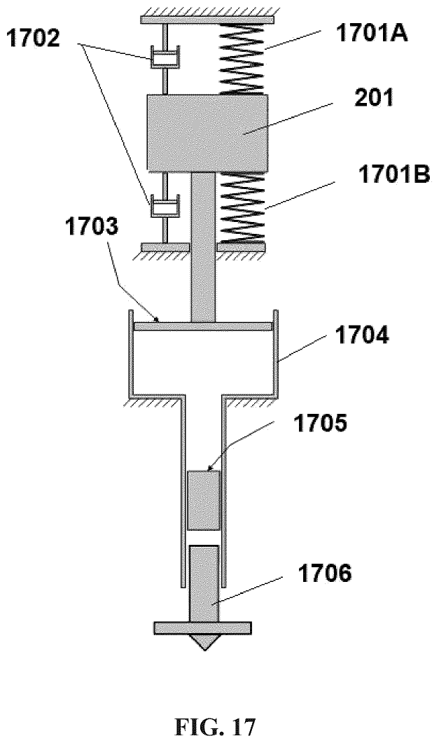

The application example of the present development of the linear induction motor device corresponds to:
1) A core of laminated silicon iron (101) with a total height of 720 mm, a stroke of 500 mm and an iron section in its central column of 3660 mm2.
2) The upper and lower primary windings (104) are 2 coils of annealed copper enameled wire, with paper insulation between the layers of the 250-turn winding, of AWG 7 gauge, for 220V and a capacity to conduct 30 A, with a density of 3 A/mm2. The coil height is 70 mm, with an inner diameter of 106 mm and an outer diameter of 206 mm. The coils have derivations to have the possibility of varying the value of the inductance. This flexibility is important because by increasing the excitation frequency of the coil that generates induction in the ring, above 50 Hz, the impedance of the coil begins to rise and the current decreases. If this happens to the point that the magnetomotive force is too low to generate mechanical power, it is convenient to lower the number of turns in the coil (use one of the derivations), to lower the inductance and with it the impedance of the coil.
3) An electrically conductive ring (201) of aluminum with a mass of 1.5 kg, with an internal diameter of 76 mm, an external diameter of 165 mm and a height of 35 mm, with 36 axial through holes of 5 mm diameter.
4) Two stainless steel springs with 8 turns of 10 mm diameter, 78 mm internal diameter and 98 mm external diameter and 160 mm high. These springs are located inside each of the upper and lower primary windings (104). When the aluminum electrically conductive ring (201) approaches one of the primary windings (104), the spring begins to store the aluminum ring (201) kinetic energy. The spring returns the kinetic energy when the closest coil is energized.
5) Stroke. Starting with the 720 mm total length of the transformer (101), and deducting the cross section of the same transformer (101) and the primary windings (104), there are 500 mm free, which correspond to the maximum stroke of the aluminum ring (201).
6) To energize each of the upper and lower primary windings (104), a 5 kVA single-phase variac was available in which one of the variac outputs goes directly to one of the poles of the primary windings (104) and the other output of the variac passes through a pair of solid state relays that alternately feed each of the primary windings (104). The control of the solid-state relays is done with a PWM signal and its negation, both to each one of the bases of two NPN 547C transistors that activate the SSRs.
7) Additionally, as can be seen in FIG. 17, there is an air chamber that transmits the movement of the electrically conductive ring (201) to the rock. In this way, the reciprocating vertical movement of the electrically conductive ring (201) generates a volume change in the air chamber (1704) that drives the piston (1705), which, in turn, strikes the chisel (1706), which in turn, hits the rock.

With the above configuration, without optimization of any kind, oscillation frequencies of the aluminum electrically conductive ring (201) are achieved above 10 Hz, with a stroke of 500 mm, theoretical currents within the aluminum electrically conductive ring (201) around at 180 kA, a current density of 115 A/mm2 and an average speed of more than 5 m/s.

As can be seen, for this application example, the frequencies developed by the aluminum electrically conductive ring (201) are comparable to the tools used in the industry with a much higher stroke. However, the application example did not consider hitting a rock, but when removing the springs and making an impact, the frequency managed to stay above 7 Hz.

FIG. 1 shows an electrical transformer, with a closed iron core, made from sheets of silicon iron (101). In one of the vertical columns of the transformer there is a primary winding (104) which, excited by the alternating source (103), generates an alternating magnetic field (102) inside the silicon laminated iron (101).

Number 101 is the laminated silicon iron core.

Number 102 corresponds to the magnetic field lines.

Number 103 is the excitation source of the primary windings (104). It can be alternating current or direct current. If it is direct current, the inductive effect on the electrically conducting ring (201) will be only in the transient period.

Number 104 corresponds to the primary winding.

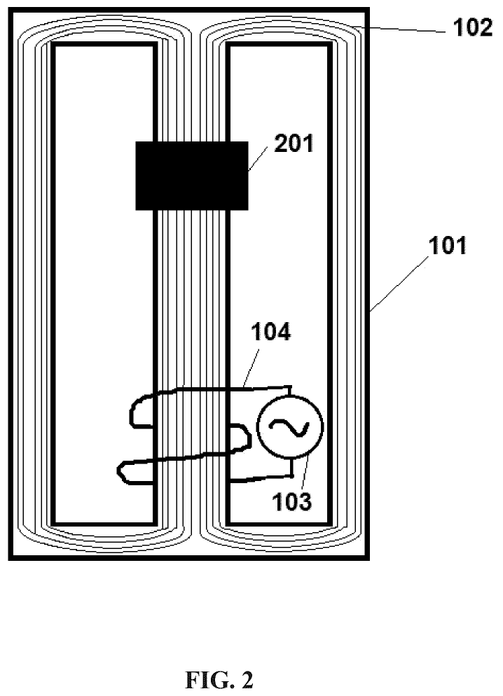

FIG. 2 shows the same electrical transformer made from silicon iron sheets (101) of FIG. 1. In this figure, the electrically conductive ring (201) is added, which will act as a mechanical oscillator.

Number 201 is the electrically conductive ring.

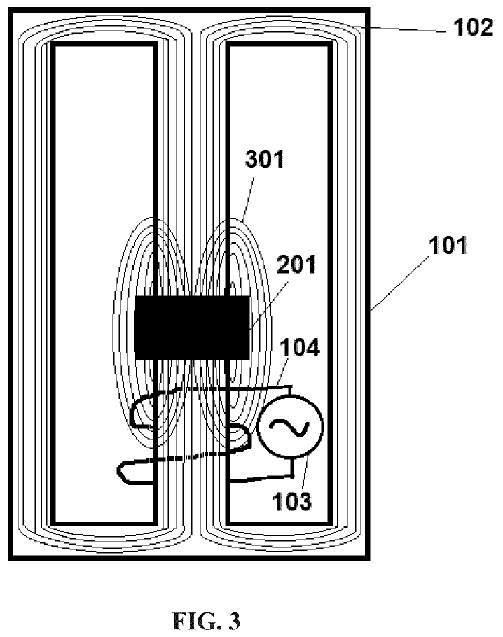

FIG. 3 shows the magnetic field (301) generated by the induced current inside the electrically conductive ring (201).

Number 301 is the magnetic field generated by the induced current in the electrically conductive ring (201), due to the alternating magnetic field (102) in the laminated silicon iron (101).

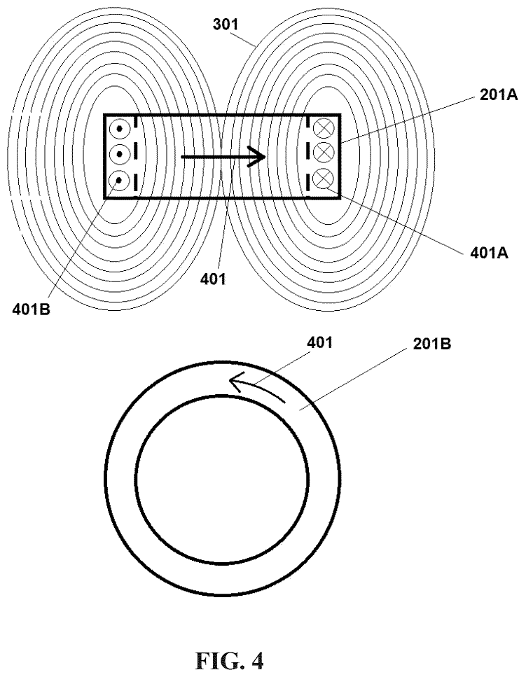

FIG. 4 shows a sectional view (201A) and a top view (201B) of the electrically conductive ring (201). The induced current (401) is appreciated in detail for each of the views. In the sectional view (201A), on the right side of the ring, it can be seen the current entering the sheet (401A). On the left side of the ring, it can be seen the current coming out of the sheet (401 B).

Number 201A is a sectional view of the electrically conductive ring (201).

Number 201B is a top view of the electrically conductive ring (201).

Number 401 is the induced current for each of the views.

Number 401A is the induced current in the electrically conductive ring (201), entering the sheet.

Number 401B is the current induced in the electrically conductive ring (201), exiting the sheet.

Number 301 is the vector magnetic field generated by the induced current 401.

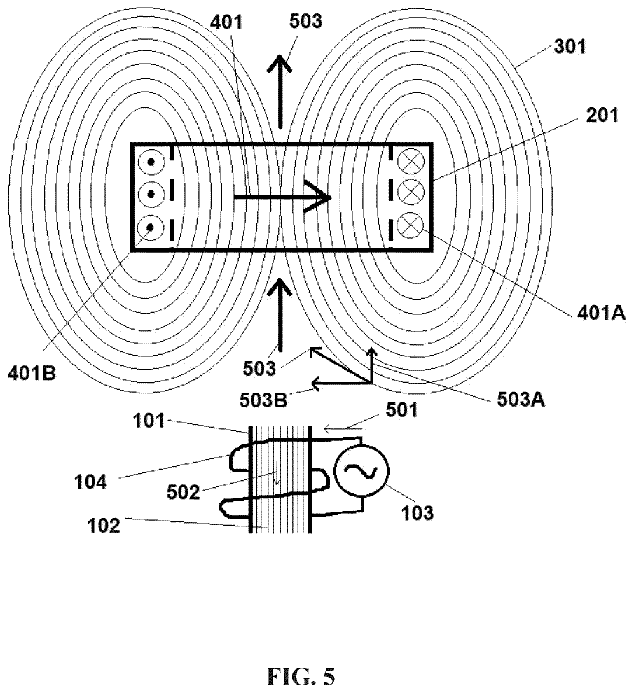

FIG. 5 shows the directions and senses of the vector magnetic field (301) generated by the induced current (401) in the electrically conducting ring (201) and the current (501) in the primary winding (104).

The magnetic field (102) in the laminated iron (101) of the transformer has a downward direction (502) in the central column of the transformer given the right-hand rule. This magnetic field in the iron (101) induces a current (401) in the electrically conductive ring (201) in the opposite direction to the original current (501). The induced current (401) generates a second magnetic field (301), whose vector field is represented by the arrows (503). As can be seen, in the center of the ring, the prevailing component is the vertical, with an upward direction, but the magnetic field, being vectorial, always has an horizontal component (503B) and a vertical component (503A).

Number 501 is the current in the primary winding (104).

Number 502 is the direction of the magnetic field (102) in the laminated iron (101) of the transformer.

Number 503 is the direction and sense of the vector magnetic field (301), in the center of the electrically conductive ring (201).

Number 503A is the vertical component of the vector magnetic field (301).

Number 503B is the horizontal component of the vector magnetic field (301).

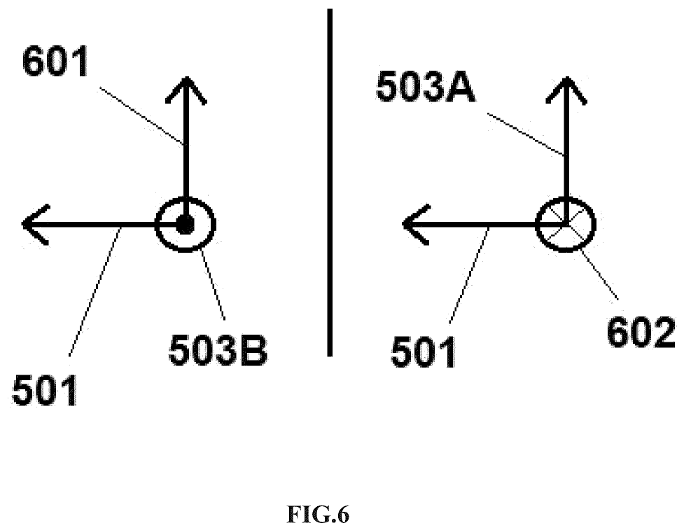

FIG. 6 shows the interaction between the vertical (503A) and horizontal (503B) components of the vector magnetic field (301) and the current (501) in the primary winding (104).

Since the alternating magnetic field (301) is a vector field, each field line has a vertical component (503A) and a horizontal component (503B). In this way, the horizontal component (503B) of the vector magnetic (301) and the current (501) of the primary winding (104) interact with each other and their vector product (F=I×B) generates a vertical repulsive force (601) between the electrically conductive ring (201) and the primary winding (104).

Likewise, the vertical component (503A) of the vector magnetic field (301) and the current (501) of the primary winding (104) interact with each other and their vector product (F=I×B) generates a radial horizontal force (602) between the electrically conductive ring (201) and the primary winding (104). This radial horizontal force (602) has a resultant equal to zero since it cancels (vectorial sum equal to zero).

Number 601 corresponds to a vertical repulsive force between the electrically conductive ring (201) and the primary winding (104).

Number 602 corresponds to a radial horizontal force between the electrically conductive ring (201) and the primary winding (104).

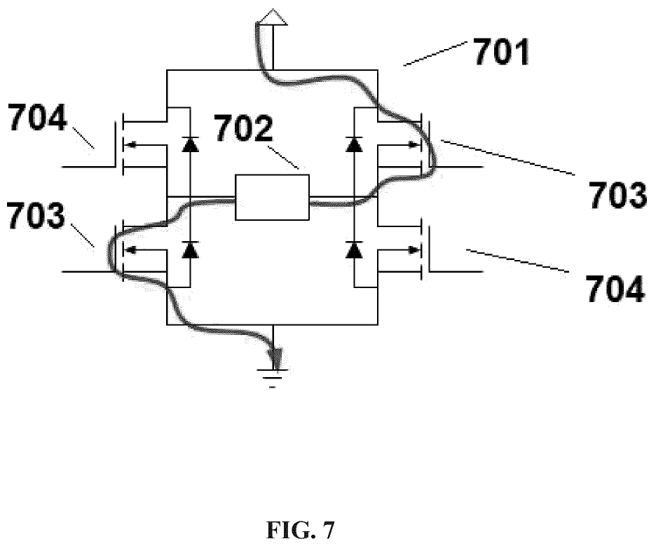

FIG. 7 shows an H-bridge (701). It is a configuration of transistors that allows the direction of the currents to be reversed in a certain load (104, 702). If it is desired to energize the primary windings (104, 702) with an H bridge (701), the same H bridge (701) allows to excite the primary windings (104, 702) to achieve the excitation of the primary windings (104, 702) and additionally alternating between them to oscillate the electrically conductive ring (201).

The H bridge (701) allows the primary windings (104, 702) to be excited to achieve a current in one direction (from positive to negative) with the activation of the transistors 703 (MOSFET, IGBT, BJT, etc). A later time instant (half an induction cycle) the transistors 703 are no longer powered and the transistors 704 are powered to generate a current flow in the reverse direction (from negative to positive).

Number 701 corresponds to the H bridge.

Number 702 corresponds to the load that feeds the H bridge, which, in this case, corresponds to the primary windings (104).

Number 703 corresponds to the group of transistors that allows the flow of current in a positive direction to the right.

Number 704 corresponds to the group of transistors that allows the flow of current in a positive direction to the left.

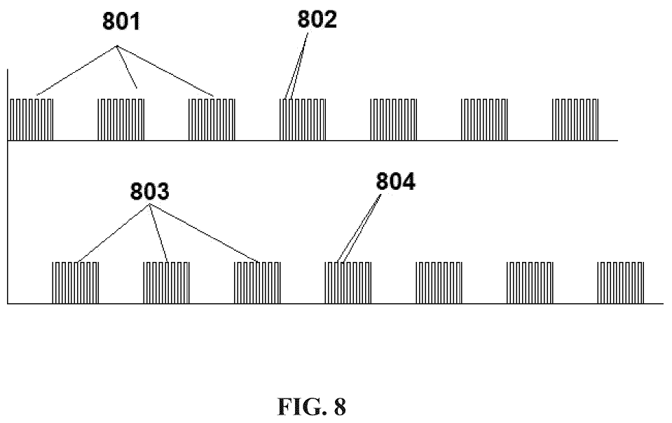

FIG. 8 shows the activation signals (input) of the H bridge (701) of the primary windings (104, 702). These signals must be 180° out of phase, in such a way as to achieve the oscillation of the electrically conductive ring (201). Thus, for a 50% duty cycle, the H-bridge drive signal (701) for the upper primary winding (104, 702) is the high-frequency induction signal (802) and also the enveloping curve (801) of low frequency, which generates the oscillation of the electrically conductive ring (201). Likewise, the drive signal of the H-bridge (701) for the lower primary winding (104, 702) is the high-frequency induction signal (804) and also the low-frequency enveloping curve (803) that generates the oscillation of the conductive ring (201).

Number 801 is the signal (input) of the H bridge (701) that feeds the upper primary winding (104). This signal is a low frequency enveloping curve that drives the transistors (703, 704) that allow current output from the H bridge to the upper primary winding (104, 702) and ensures the oscillation of the electrically conductive ring (201). As can be seen in the figure, the duty cycle is 50%.

Number 802 is the signal (input) of the H bridge (701) that feeds the upper primary winding (104). This is the high frequency excitation signal that drives the transistors (703, 704) and allows current output from the H bridge to the upper primary winding (104, 702), which ensures the induction of currents in the ring. electrical conductor (201). As can be seen in the figure, the duty cycle is 50%.

Number 803 is the signal (input) of the H bridge (701) that feeds the lower primary winding (104). This signal is a low frequency enveloping curve that drives the transistors (703, 704) and allows current output from the H bridge to the lower primary winding (104, 702) and ensures the oscillation of the electrically conductive ring (201). As can be seen in the figure, the duty cycle is 50%.

Number 804 is the signal (input) of the H bridge (701) that feeds the lower primary winding (104). This is the high-frequency excitation signal that drives the transistors (703, 704) and allows current output from the H-bridge to the lower primary winding (104, 702), which ensures the induction of currents in the ring. electrical conductor (201). As can be seen in the figure, the duty cycle is 50%.

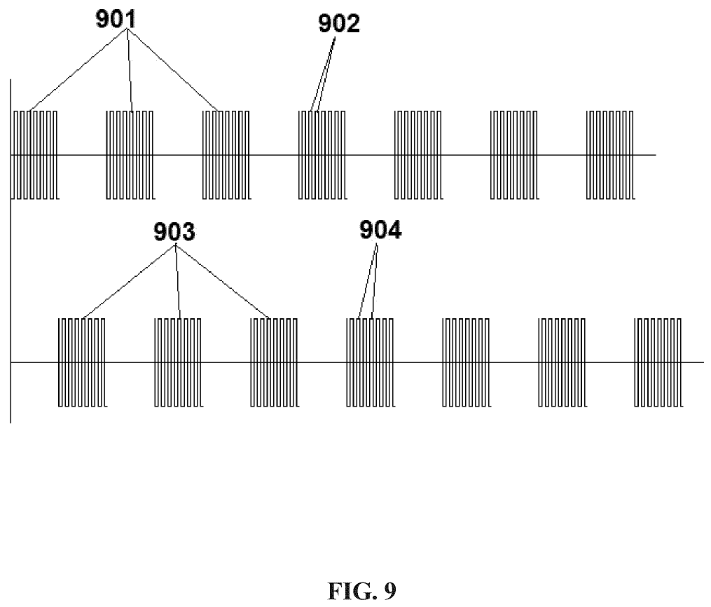

FIG. 9 shows the voltage (in case H-bridge is a voltage source) or current (in case H-bridge is a current source) output from H-bridge (701) to the primary windings (104, 702).

These voltages or currents are 180° out of phase, in such a way as to achieve the oscillation of the electrically conductive ring (201). In this way, for a 50% duty cycle, the output current of the H-bridge (701) for the upper primary winding (104, 702) is the high-frequency current that generates induction (902) and also the enveloping current curve of low frequency (901) that generates the oscillation of the electrically conductive ring (201). Likewise, the output current of the H-bridge for the lower primary winding (104, 702) is the high-frequency current that generates induction (904) and also the low-frequency enveloping current curve (903) that generates the oscillation of the electrically conductive ring (201).

Number 901 is the voltage that from the H bridge (701) feeds the upper primary winding (104). This voltage is low frequency and generates the H-bridge current to the upper primary winding (104, 702). It is this current that ensures the oscillation of the electrically conductive ring (201). As can be seen in the figure, the duty cycle is 50%.

Number 902 is the voltage that feeds the upper primary winding (104) from the H bridge (701). This voltage is the high frequency excitation that allows current output from the H bridge towards the upper primary winding (104, 702), which ensures the induction of currents in the electrically conductive ring (201). As can be seen in the figure, the duty cycle is 50%.

Number 903 is the voltage that feeds the lower primary winding (104) from the H bridge (701). This voltage is low frequency and generates the current output from the H-bridge to the lower primary winding (104, 702). This current ensures the oscillation of the electrically conductive ring (201). As can be seen in the figure, the duty cycle is 50%.

The number 904 is the voltage from the H bridge (701) that feeds the lower primary winding (104). This voltage is the high-frequency excitation and generates the current output from the H-bridge towards the lower primary winding (104, 702), which ensures the induction of currents in the electrically conducting ring (201). As can be seen in the figure, the duty cycle is 50%.

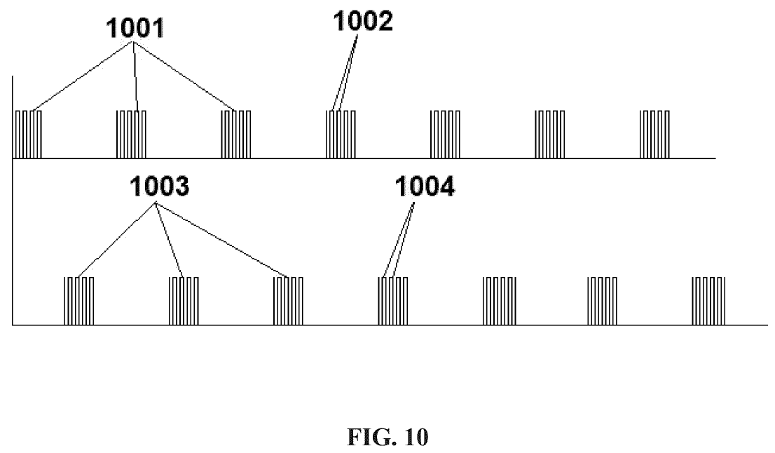

FIG. 10 shows the drive signals (input) of the H bridge (701) of the primary windings (104, 702). These signals must be 180° out of phase, in such a way as to achieve the oscillation of the electrically conductive ring (201). In this way, for a duty cycle of less than 50%, the activation signal of the H bridge (701) for the upper primary winding (104, 702) is the induction signal (1002) and also the enveloping curve (1001) that generates the oscillation of the electrically conductive ring (201). Likewise, the drive signal of the H-bridge (701) for the lower primary winding (104, 702) is the induction signal (1004) and also the enveloping curve (1003) that generates the oscillation of the electrically conductive ring (201).

Number 1001 is the signal (input) of the H bridge (701) that feeds the upper primary winding (104). This signal is a low frequency enveloping curve that drives the transistors (703, 704) that allow current output from the H bridge to the upper primary winding (104, 702) and ensures the oscillation of the electrically conductive ring (201). As can be seen in the figure, the duty cycle is less than 50%.

Number 1002 is the signal (input) of the H bridge (701) that feeds the upper primary winding (104). This is the high frequency excitation signal that drives the transistors (703, 704) and allows current output from the H bridge to the upper primary winding (104, 702), which ensures the induction of currents in the aluminum ring (201). As can be seen in the figure, the duty cycle is less than 50%.

Number 1003 is the signal (input) of the H bridge (701) that feeds the lower primary winding (104). This signal is a low frequency enveloping curve that drives the transistors (703, 704) and allows current output from the H bridge to the lower primary winding (104, 702) and ensures the oscillation of the electrically conductive ring (201). As can be seen in the figure, the duty cycle is less than 50%.

Number 1004 is the signal (input) of the H bridge (701) that feeds the lower primary winding (104). This is the high-frequency excitation signal that drives the transistors (703, 704) and allows current output from the H-bridge to the lower primary winding (104, 702), which ensures the induction of currents in the aluminum ring (201). As can be seen in the figure, the duty cycle is less than 50%.

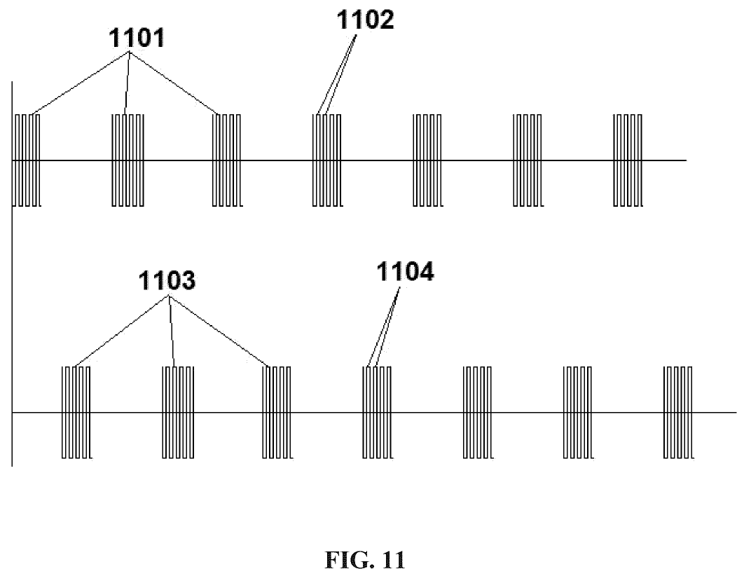

FIG. 11 shows the voltage (in case H-bridge is a voltage source) or current (in case H-bridge is a current source) output from H-bridge (701) to the primary windings (104, 702).

These voltages or currents are 180° out of phase, in such a way as to achieve the oscillation of the electrically conductive ring (201). In this way, for a duty cycle of less than 50%, the output current of the H-bridge (701) for the upper primary winding (104, 702) is the high-frequency current that generates induction (1102) and also the current low frequency enveloping curve (1101) that generates the oscillation of the electrically conductive ring (201). Likewise, the output current of the H-bridge for the lower primary winding (104, 702) is the high-frequency current that generates induction (1104) and also the low-frequency enveloping current curve (1103) that generates the oscillation of the electrically conductive ring (201).

The number 1101 is the voltage that feeds the upper primary winding (104) from the H bridge (701). This voltage is low frequency and generates the H-bridge current to the upper primary winding (104, 702). It is this current that ensures the oscillation of the electrically conductive ring (201). As can be seen in the figure, the duty cycle is less than 50%.

The number 1102 is the voltage that feeds the upper primary winding (104) from the H bridge (701). This voltage is the high frequency excitation that allows current output from the H bridge towards the upper primary winding (104, 702), which ensures the induction of currents in the electrically conductive ring (201). As can be seen in the figure, the duty cycle is less than 50%.

The number 1103 is the voltage that feeds the lower primary winding (104) from the H bridge (701). This voltage is low frequency and generates the current output from the H-bridge to the lower primary winding (104, 702). This current ensures the oscillation of the electrically conductive ring (201). As can be seen in the figure, the duty cycle is less than 50%.

The number 1104 is the voltage from the H bridge (701) that feeds the lower primary winding (104). This voltage is the high-frequency excitation and generates the current output from the H-bridge towards the lower primary winding (104, 702), which ensures the induction of currents in the electrically conducting ring (201). As can be seen in the figure, the duty cycle is less than 50%.

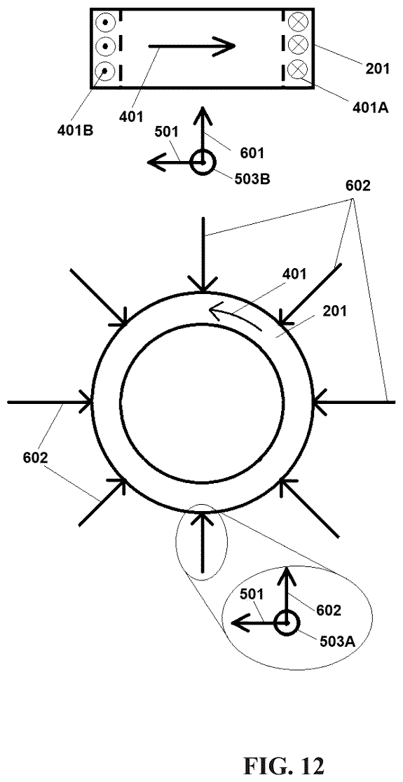

FIG. 12 shows an elevation view of the electrically conductive ring (201) and a top view of the electrically conductive ring (201). The forces acting on the electrically conductive ring (201) can be observed.

In the elevation view, the vertical-axial force (601) exerted on the electrically conductive ring (201) can be observed, which is responsible for its oscillation within the electrical transformer (101).

Since the alternating magnetic field (301) is a vector field, each field line has a vertical component (503A) and an horizontal component (503B). In this way, the horizontal component (503B) of the vector magnetic (301) and the current (501) circulating in the primary winding (104) interact with each other. Its cross product (F=I×B) generates a vertical repulsive force (601) between the electrically conducting ring (201) and the primary winding (104).

In the top view, the horizontal-radial force (602) exerted on the electrically conductive ring (201) can be observed, which is responsible for the electrically conductive ring (201) self-centering in the central column of the electrical transformer. (101).

Likewise, the vertical component (503A) of the vector magnetic field (301) and the current (501) of the primary winding (104) interact with each other and their vector product (F=I×B) generates a radial horizontal force (602) between the electrically conductive ring (201) and the primary winding (104). This radial horizontal force (602) has a resultant equal to zero, since it cancels (vectorial sum equal to zero). This allows the electrically conductive ring (201) to self-center on the central column of the electrical transformer (101).

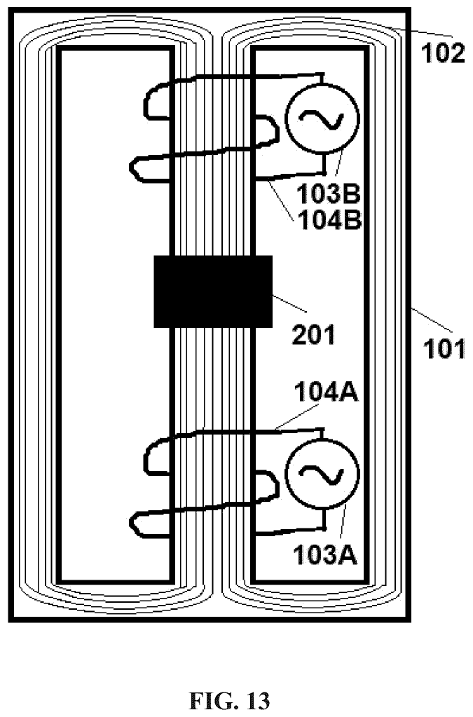

FIG. 13 is the complete schematic of the reciprocating induction linear motor device. The upper (104 A) and lower (104 B) windings (104) can be seen, which, alternately energized, allow the electrically conductive ring (201) to oscillate.

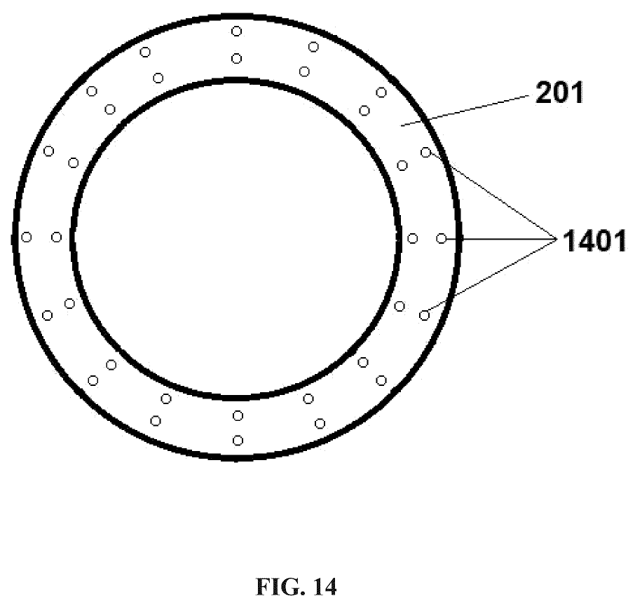

FIG. 14 shows a top view of the electrically conductive ring (201) and its axial through-holes (1401) which have a dual purpose. On the one hand, to reduce the aerodynamic resistance of the ring with the air and on the other hand, to ensure its cooling, given the very high currents (401) circulating inside it. As the ring will oscillate traveling through the central column of the transformer (101) at a high frequency (of the order of tens of Hz), its average speed is of the order of tens of meters per second. This means that the air will travel through the axial perforations (1401) at a high speed, ensuring the cooling of the electrically conductive ring (201).

Number 1401 corresponds to the axial through-holes in the electrically conductive ring (201).

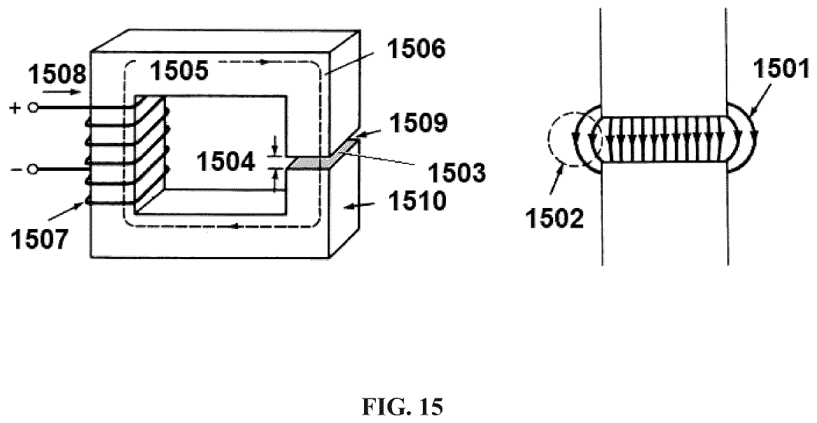

FIG. 15 plots the existence of an air gap (1504) in a magnetic circuit (given by the field lines (1505)). This air gap (1504) is the distance of air (1509) with a very low magnetic permeability compared to the iron zone (1510) which has a magnetic permeability several orders of magnitude higher. Depending on the material, it can be of the order of 100 to 1000 times. The effect of this air gap (1504) is such that the magnetic circuit (1505) finds it difficult to generate a high field density inside the iron, generating a border effect (1502), in which the field becomes less dense (less field lines (1501) per unit area (1503)).

The air gap (1504) generates a high reluctance in the magnetic circuit (1505). As in electrical circuits, where a high resistance prevents the passage of current, in the case of magnetic circuits a high reluctance (due to air gaps) prevents the passage of magnetic flux. This generates that for the same excitation (magnetomotive force N*I, given by the product of the winding of N turns (1507) and the current circulating in the winding (1508)), a lower field density is obtained (magnetic field lines (1501) divided by the cross section of the iron core (1503)) in the magnetic core.

Number 1501 corresponds to the magnetic field lines in the air gap.

Number 1502 plots the boundary effect on the air gap.

Number 1503 is the cross section of the iron core.

Number 1504 is the air gap.

Number 1505 corresponds to the magnetic field lines.

Number 1506 is the length of the iron core.

Number 1507 is the winding with N turns.

Number 1508 is the current circulating in the winding.

Number 1509 is the zone with magnetic permeability equal to that of air.

Number 1510 is the area with magnetic permeability equal to that of iron.

FIG. 16 shows a variation of the linear reciprocating induction motor device, in which the electrically conductive ring (201) is double and oscillates in both columns of the transformer (101). This configuration is very efficient in terms of the space used by the device.

FIG. 17 shows the dynamic model of the induction reciprocating linear motor device, by way of example and without restricting the field of application of the induction reciprocating linear motor device, in a possible configuration for the hammer. As seen in FIG. 17, the electrically conductive ring (201) is restricted in its vertical movement by two ideal springs: the upper ideal spring (1701A) and the lower ideal spring (1701B). These ideal springs (1701A, 1701B) are converted into real springs through the dynamic model that conceptualizes them in parallel with dampers (1702).

The reciprocating vertical movement of the electrically conductive ring (201) generates a volume change in the air chamber (1704) which drives the piston (1705), which in turn strikes the chisel (1706), which in turn strikes the rock.

Number 1701A corresponds to the superior ideal spring.

Number 1701B corresponds to the lower ideal spring.

Number 1702 corresponds to two dampers that make the action of the springs (1701A, 1701 B) real, according to the dynamic model of FIG. 17.

Number 1703 corresponds to the larger plunger in the air chamber (1704).

Number 1704 is the air chamber that transmits the movement of the electrically conductive ring to the piston (1705).

Number 1705 is the piston which in turn strikes the chisel (1706) which in turn strikes the rock.

Number 1706 is the chisel that hits the rock.

1. A linear reciprocating induction motor device, comprising:
an electrically conductive ring, wherein the ring does not make electrical contact with any element of the device and oscillates inside a closed-core, dry, single-phase electrical transformer configured as a closed magnetic circuit, wherein the ring has no air gaps other than air gaps of the construction of the closed magnetic circuit; and
two independent primary windings of enameled annealed wire or insulated, refrigerated annealed tubing, wherein an upper primary winding and a lower primary winding of the two independent primary windings are positioned above and below the electrically conductive ring;
wherein the enameled annealed wires or the insulated, refrigerated annealed tubing are wound on an electrically insulating reel.

2. The linear reciprocating induction motor device of claim 1, wherein the electrically conductive ring oscillates on a ferrous material, and is confined within a magnetic circuit of the ferrous material, in its central column.

3. The linear reciprocating induction motor device of claim 1, wherein a ferrous core of the transformer is made of a ferrous material.

4. The linear reciprocating induction motor device of claim 1, wherein the electrically conductive ring has perforations.

5. The linear reciprocating induction motor device of claim 1, wherein the ring and the internal structure of the transformer are cooled by one or more gases selected from the group consisting of air, dry air, sulfur hexafluoride, an inert gas, and a dielectric gas.

6. The linear reciprocating induction motor device of claim 1, wherein a distance between the upper and lower coils is variable to expand the frequency range in which the device can oscillate.

7. A method of operating the reciprocating linear induction motor device of claim 1, the method comprising:
(a). injecting alternating or continuous electrical current into one of the two lower or upper primary windings, directly from an electrical network;
(b). generating circulation of induced current in the electrically conductive ring and an associated magnetic field, without any electrical contact between the electrically conductive ring and any element of the device, all this due to the injected electrical current in step (a);
(c). exciting the primary windings alternately and complementary with direct or alternating current;
(d) making the electrically conductive ring oscillate in response to interaction between the magnetic field and current of the primary winding; and
moving a mechanical, hydraulic, or pneumatic element using oscillations of the electrically conductive ring.

8. The method of claim 7, wherein, in step (c), the excitation of the coils, to generate the oscillating movement, is carried out from direct current or alternating current, controlling the frequencies externally through one or more devices selected from the list consisting of: relays with moving parts, solid-state relays, simple circuits with transistors, and an H-bridge, to simultaneously generate greater magnetic induction in the electrically conducting ring than could otherwise be achieve with the frequency of the network and additionally control oscillation of the magnetic induction between the coils.

9. (canceled)

10. The linear reciprocating induction motor device according to claim 1, wherein the electrically conductive ring oscillates on a ferrous material and is confined within a magnetic circuit of the ferrous material, in lateral columns, always between two coils of the primary windings.

11. The linear reciprocating induction motor device according to claim 3, wherein the ferrous core of the transformer comprises ferrite, grain-oriented silicon laminated iron, or annealed iron wire.
